(19) United States
(12) Patent Application Publication
(10) Pub. No.: US 2020/0187455 A1
(43) Pub. Date: Jun. 18, 2020

(54) PET BATHING APPARATUS

(71) Applicant: Channell Smith, Philadelphia, PA (US)

(72) Inventor: Channell Smith, Philadelphia, PA (US)

(21) Appl. No.: 16/719,958

(22) Filed: Dec. 18, 2019

Related U.S. Application Data
(60) Provisional application No. 62/781,277, filed on Dec. 18, 2018.

(51) Int. Cl. A01K 13/00; A01K 15/04

(52) U.S. Cl. CPC A01K 13/001; A01K 15/04

(57) ABSTRACT

A pet bathing apparatus to bathe a pet therein, the pet bathing apparatus including a main body having a cage-like design to allow the pet to be disposed therein, a water sprayer connected to a water source to provide water to the water sprayer to allow a user to wash the pet disposed within the main body, and a holder disposed at a portion of the main body to allow the water sprayer to be detachably stored at the portion of the main body.

### CROSS REFERENCE TO RELATED APPLICATION

This application claims the benefit of, and incorporates by reference, U.S. provisional patent application Ser. No. 62/781,277, entitled “Pet Bathing Apparatus,” which was filed on Dec. 18, 2018.

### BACKGROUND

### 1. Field

The present general inventive concept relates generally to a bathing apparatus, and particularly, to a pet bathing apparatus.

### 2. Description of the Related Art

Pets usually engage in self-grooming habits, but their overall cleanliness or odor does not satisfy their owners.

Regular baths are a crucial regimen for maintaining healthy fur on cats, but bathing reluctant cats can be difficult for cat owners because they often jump out of tubs to avoid water. Currently, there are various tools that exist for aiding in the cat grooming process, however, none prevent cats from escaping.

Therefore, there is a need for devices that aid in keeping cats in the tub during baths.

### SUMMARY

The present general inventive concept provides a pet bathing apparatus.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a pet bathing apparatus to bathe a pet therein, the pet bathing apparatus including a main body having a cage-like design to allow the pet to be disposed therein, a water sprayer connected to a water source to provide water to the water sprayer to allow a user to wash the pet disposed within the main body, and a holder disposed at a portion of the main body to allow the water sprayer to be detachably stored at the portion of the main body.

The main body may include a first side, a second side connected to the first side, a third side connected to the second side, a fourth side connected to the third side and the second side, a bottom side connected to bottom edges of the first side, the second side, the third side, and the fourth side, a lid hingedly and pivotably connected to a top edge of the third side to cover a top portion of the main body, and a hinge to provide the hinged and pivotable connection.

The main body may further include a first arm hole disposed on at least a portion of the second side to allow the user to access an inner portion of the main body though the second side, and a second arm hole disposed on at least a portion of the fourth side to allow the user to access an inner portion of the main body though the fourth side.

The pet bathing apparatus may further include a pad disposed within the main body at the bottom side.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front view of a pet bathing apparatus, according to an exemplary embodiment of the present general inventive concept; and

FIG. 2 illustrates a side view of a pet bathing apparatus, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

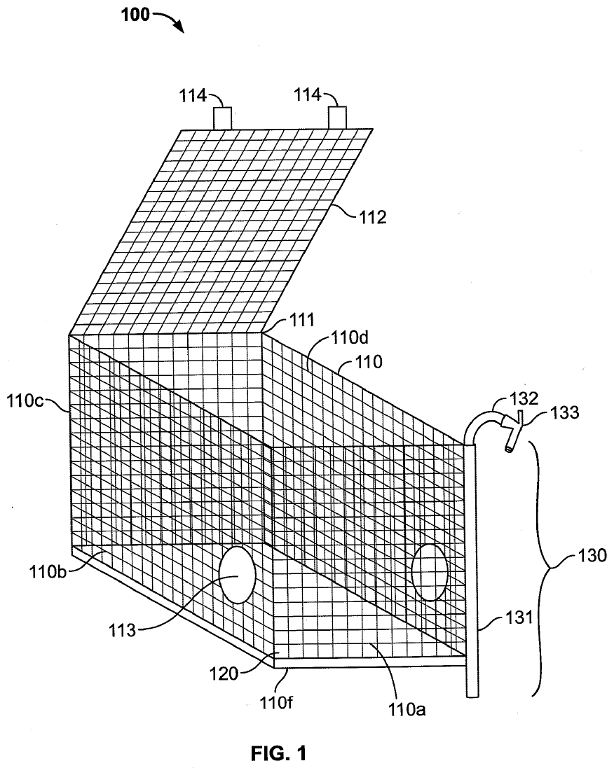

FIG. 1 illustrates a front view of a pet bathing apparatus 100, according to an exemplary embodiment of the present general inventive concept.

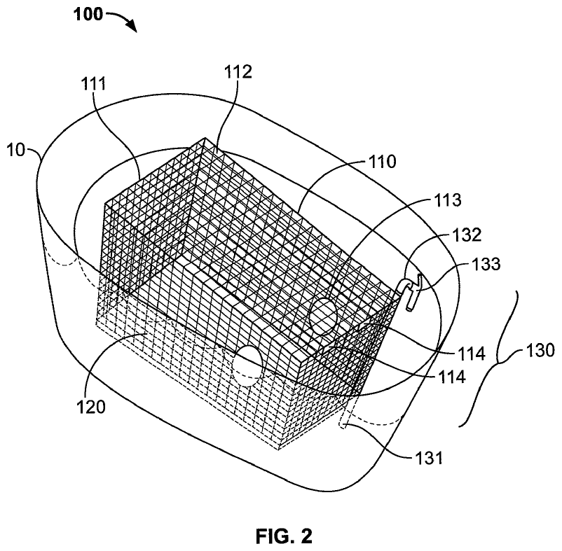

FIG. 2 illustrates a side view of a pet bathing apparatus 100, according to an exemplary embodiment of the present general inventive concept.

The pet bathing apparatus 100 may be constructed from at least one of hard plastic, soft plastic, rubber, silicone, gel, metal, etc., but is not limited thereto. The pet bathing apparatus 100 may be lightweight and easy to carry by a user.

The pet bathing apparatus 100 may include a main body 110, a pad 120, and a water sprayer 130.

Referring to FIG. 1, the main body 110 is illustrated to have a rectangular prism shape. However, the main body 110 may be rectangular, circular, conical, spherical, or any feasible shape desired by the user. The main body 110 may be constructed to have a cage-like design formed of interconnected bars. The main body 110 may be of predetermined size to accommodate pets of various sizes.

The main body 110 may include a first side 110a, a second side 110b, a third side 110c, a fourth side 110d, a top side 110e, a bottom side 110f, a hinge 111, a lid 112, and at least one arm hole 113, but is not limited thereto.

The main body 110 may be collapsible along any edge and/or juncture between any sides of the main body 110 in any feasible configuration. In other words, the main body 110 may be folded to a compact configuration, for easy storage.

The hinge 111 may be disposed at a top edge of the third side 110c next to the top side 110e. The hinge 111 may extend across at least a portion of a length of the top edge of the third side 110c, beginning from the second side 110b next to the top side 110e, and terminating at the fourth side 110d next to the top side 110e. Although, the hinge 111 is illustrated in FIG. 1 to be disposed at a top edge of the third side 110c next to the top side 110e, the hinge 111 may be disposed at any top edges of the first side 110a, the second side 110b, or the fourth side 110d.

Referring to FIG. 1, the lid 112 may be attached at a first end thereof to the top edge of the third side 110c via the hinge 111, and may include at least one latch 114 disposed at a second end of the lid 112. However, the at least one latch 114 may be disposed on the lid 112 at any feasible location. The lid 112 may be removably affixed and/or adhered to the hinge 111. The lid 112 may be of a same length as the hinge 111 at the point of attachment, but is not limited thereto, as the hinge 111 may be disposed on only a portion of the top edge of the third side 110c. Furthermore, the lid 112 may pivot about the hinge 111. The lid 112 may rest on the main body 110 such that the lid 112 covers the main body 110 to be completely enclosed. In other words, all edges of the lid 112 may be in contact with the top edges of the first side 110a, the second side 110b, the third side 110c, and the fourth side 110d, so as to enclose the top side 110e. As such, the lid 112 is considered closed.

Additionally, the lid 112 may be locked onto the main body 110 using the at least one latch 114. The at least one latch 114 may be affixed and/or adhered to the main body 110 by at least one of hooking onto at top edge of the main body 110, and/or magnetically coupling to the main body 110.

The lid 112 may be opened by pivoting the lid 112 with respect to the hinge 111, away from the main body 110. Specifically, the lid 112 may pivot about the hinge 111 such that the lid 112 is only in contact with the hinge 111. As such, the lid 112 is considered opened. Moreover, the user may place his/her pet within the main body 110. Once the pet is inside the main body 110, the user may close the lid 112.

Alternatively, the lid 112 may slide along a top portion of the main body 110 to open and/or close the top portion of the main body 110 to allow access into an inner portion of the main body 110, or may be removed therefrom.

Although, the at least one arm hole 113 is illustrated in FIG. 1 to be disposed on at least a portion of the second side 110b and on at least a portion of the fourth side 110d, the at least one arm hole may be disposed on at least a portion of the first side 110a, at least a portion of the third side 110c, at least a portion of the bottom side 110f, and at least a portion of the lid 112. Moreover, although, the at least one arm hole 113 is illustrated in FIG. 1 to be circular shaped, the at least one arm hole 113 may be rectangular prism, rectangular, conical, pentagonal, hexagonal, octagonal, or any other shape known to one of ordinary skill in the art, but is not limited thereto. Furthermore, the at least one arm hole 113 may have a door (not illustrated) disposed thereon.

The pad 120 may be constructed from at least one of closed-cell extruded polystyrene foam, wood, plastic, etc., but is not limited thereto. Furthermore, the pad 120 may float when placed in a body of water, but is not limited thereto.

The pad 120 may be disposed within the main body 110, at the bottom side 110f.

Referring to FIGS. 1 and 2, the user may touch and/or grab his or her pet within the main body 110 via the at least one arm hole 113, onto the pad 120. Specifically, the user may insert his or her arm through the at least one arm hole 113 by pushing at least one hand through the at least one arm hole 113. The user may stabilize the pet using his or her hands within the main body 110. The pad 120 may allow the pet to stand while the main body 110 is in a bathtub 10 filled with water. As such, the pad 120 may prevent the pet from standing in the water directly.

The water sprayer 130 may include a holder 131, a hose 132, and a nozzle 133. The water sprayer 130 may be disposed on at least a portion of an exterior of the main body 110. Although, the water sprayer 130 is illustrated in FIG. 1 to be disposed on the first side 110a next to the fourth side 110d, the water sprayer 130 may be disposed on the second side 110b, the third side 110c, or the fourth side 110d. The holder 131 may support the hose 132 and the nozzle 133. The hose 132 may be removably disposed within the holder 131. Furthermore, the hose 132 may slide within the holder 132. The nozzle 133 may be disposed on an end of the hose 132. The nozzle 133 may dispense water by squeezing a handle on the nozzle 133. The user may extend the hose 132 by pulling the hose 132 away from the holder 131. Additionally, the user may insert the nozzle 133 and the hose 132 through the at least one arm hole 113. As such, the user may clean the pet by squeezing the handle on the nozzle 133 to dispense water and target specific areas of the pet the user intends to clean.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A pet bathing apparatus to bathe a pet therein, the pet bathing apparatus comprising:
a main body having a cage-like design to allow the pet to be disposed therein;
a water sprayer connected to a water source to provide water to the water sprayer to allow a user to wash the pet disposed within the main body; and
a holder disposed at a portion of the main body to allow the water sprayer to be detachably stored at the portion of the main body.

2. The pet bathing apparatus of claim 1, wherein the main body comprises:
a first side;
a second side connected to the first side;
a third side connected to the second side;
a fourth side connected to the third side and the second side;
a bottom side connected to bottom edges of the first side, the second side, the third side, and the fourth side;
a lid hingedly and pivotably connected to a top edge of the third side to cover a top portion of the main body; and
a hinge to provide the hinged and pivotable connection.

3. The pet bathing apparatus of claim 2, wherein the main body further comprises:
a first arm hole disposed on at least a portion of the second side to allow the user to access an inner portion of the main body though the second side; and
a second arm hole disposed on at least a portion of the fourth side to allow the user to access an inner portion of the main body though the fourth side.

4. The pet bathing apparatus of claim 1, further comprising:
a pad disposed within the main body at the bottom side.
